(19) United States
(12) Patent Application Publication
(10) Pub. No.: US 2024/0174156 A1
(43) Pub. Date: May 30, 2024

(54) VEHICLE MODULE CLIP

(71) Applicant: DAEHAN SOLUTION CO., LTD, Incheon (KR)

(72) Inventors: Choong Ho KWON, Seoul (KR); Dong-Ho CHOI, Incheon (KR)

(73) Assignee: DAEHAN SOLUTION CO., LTD, Incheon (KR)

(21) Appl. No.: 18/515,341

(22) Filed: Nov. 21, 2023

(30) Foreign Application Priority Data
Nov. 29, 2022 (KR) 10-2022-0162278

(51) Int. Cl. B60N 3/02

(52) U.S. Cl. CPC B60N 3/026; B60Y 2200/11; B60Y 2304/07

(57) ABSTRACT

The present invention is directed to providing a vehicle module clip, in which two elastic arms are formed by cutting portions of supporting arms constituting two facing hooks formed on both sides of a base, soft holes are formed in flanges for supporting the elastic arms to allow the elastic arms to be easily deformed so that not only the vehicle module clip can be easily assembled using a small force but a force required to disassembly the module clip at an angle of 45° can also be reduced, and thus the members and the module can be easily disassembled using a small force without damage.

### CROSS-REFERENCE TO RELATED APPLICATION

This application claims priority to and the benefit of Korean Patent Application No. 10-2022-0162278, filed on Nov. 29, 2022, the disclosure of which is incorporated herein by reference in its entirety.

### BACKGROUND

### 1. Field of the Invention

The present invention relates to a vehicle module clip, and more specifically, to a vehicle module clip in which a pair of hooks formed to be obliquely bent from both sides of a base to face each other and forcibly fitted into and assembled with a coupling hole of a second member are formed such that an angle between the hooks is narrow and a soft hole is formed in a flange for supporting an elastic arm configured to actually perform a hooking operation to allow the elastic arm to be easily deformed, and therefore the vehicle module clip can be easily assembled using a small force when forcibly fitted into and assembled with the coupling hole and easily disassembled at an angle of 45° when disassembled.

### 2. Discussion of Related Art

In general, a module clip is used in a vehicle to couple two members into one such as when fixing an assist handle, and then to easily separate and reassemble the members as necessary. Such a module clip (fixture) is manufactured to be easily assembled or disassembled mainly using elasticity as described in Patent Document 1 to Patent Document 3 below.
(Patent Document 1) Korean Patent Registration No. 10-1658519

The invention is directed to providing a fixture for mounting a vehicle auxiliary handle, which can be easily mounted using a small force when mounted and easily dismounted using a small force when dismounted as necessary. In particular, the invention is also directed to proving a fixture for mounting a vehicle auxiliary handle manufactured through a method of pressing one panel or the like, in which widths, areas, heights, and the like of components are changed to mount or dismount the fixture using a small force so as to mount or dismount an auxiliary handle, and a fixed state of the auxiliary handle is also stably maintained.
(Patent Document 2) Korean Patent Registration No. 10-1275024

The invention is directed to providing a clip module for assembling a vehicle indoor handle, which improves the assembly performance of a clip using a minimum assembly force by minimizing a contact area between the clip for fixing an indoor handle and a vehicle body panel. In addition, the invention is also directed to providing a clip module for assembling a vehicle indoor handle, in which a pair of clips for fixing an indoor handle are integrally formed on a base plate to fix mounting positions of the clips or a fastening position of the indoor handle so that an assembly operation can be easily quickly performed through a one-touch method.
(Patent Document 3) Korean Patent Publication No. 10-2013-0094887

The invention is directed to providing a clip module for assembling a vehicle indoor handle, in which an indoor handle is fixed through an insertion method using a divided pin type clip to easily quickly assemble the clip module without a fixing unit such as a screw so as to improve productivity. In particular, the invention is also directed to providing a clip module for assembling a vehicle indoor handle, in which an injection or extrusion method is adopted for forming each of a clip and a base plate to mass-produce the clip modules in a short time so as to further improve production efficiency.

### RELATED ART

### Patent Document

(Patent Document 1) Korean Patent Registration No. 10-1658519 (Registration Date: Sep. 12, 2016)
(Patent Document 2) Korean Patent Registration No. 10-1275024 (Registration Date: Jun. 10, 2013)
(Patent Document 3) Korean Patent Publication No. 10-2013-0094887 (Publication Date: Aug. 27, 2013)

### SUMMARY OF THE INVENTION

However, the conventional module clips have the following problems.
(1) In the conventional module clip, two hooks to be deformed due to elastic support are positioned to face each other, and a hooking operation is performed while the hooks are fitted into a coupling hole, contracted, and restored to an original state. Accordingly, in order for the module clip to be firmly fixed to a member, a force for deforming the two hooks being fitted into the coupling hole, that is, an insertion force, should be great.
(2) Accordingly, not only a module clip should be assembled by being pressed by a strong force when members are coupled using the module clip, but the module clip also should be held and pulled by a greater force than the insertion force when the members need to be disassembled as necessary.
(3) Accordingly, a strong force is needed when the members are assembled using the module clip and the members are disassembled, and in addition, the module clip cannot be used anymore because the members are torn or the module clip is severely deformed when a very strong force is applied.
(4) Meanwhile, a deviation occurs in the module clip during a thermal or machining process while the module clip is manufactured, which may cause problems that the module clip is assembled using a stronger force, and a force greater than the stronger force is required when disassembling the module clip.

The present invention is directed to providing a vehicle module clip, in which two elastic arms are formed by cutting portions of supporting arms constituting two facing hooks formed on both sides of a base, soft holes are formed in flanges for supporting the elastic arms to allow the elastic arms to be easily deformed so that not only the vehicle module clip can be easily assembled using a small force but a force required to disassembly the module clip at an angle of 45° can also be reduced, and thus the members and the module are easily disassembled using a small force without damage.

According to an aspect of the present invention, there is provided a vehicle module clip assembled by being fastened to a first member using a screw and fitted into a coupling hole (11) formed in a second member (10), the vehicle module clip including a base (110) fastened to the first member using the screw and a pair of hooks (120) that are bent from portions of both edges of the base (110) and fitted into and assembled with the coupling hole (11), wherein the base (110) includes guides (112) positioned between the two hooks (120) and cut to protrude to face each other, the guides (112) are formed such that a distance between two guides (112) facing each other decreases as a distance from the base (110) to the two guides (112) increases, and the hooks (120) includes a pair of facing support arms (121) formed on both sides of the base (110) to be obliquely bent toward each other, flanges (122) that are bent from protruding ends of the support arms (121) to face each other and maintain a predetermined distance therebetween, two pairs of elastic arms (123) which are formed by cutting central portions of the support arms (112) to be unfolded outward from the flanges (122) and of which a width (W) and an angle (θ) between two elastic arms (123) are in the range of 15.8 mm to 16.2 mm and the range of 48° and 52°, respectively, steps (124) that are bent from end portions of the elastic arms 123 to face each other and caught in the coupling hole (11), two first soft grooves (122a) formed in portions of the flanges (122) in contact with the elastic arms (123), and one or more second soft grooves (122b) formed in the flanges 122 to be positioned between the two first soft grooves (122a).

In particular, one or more beads (126) may be further formed on the support arms (121) in an outward direction of the base (110), and one or more beads (127) may be further formed on the elastic arms (123) in the outward direction of the base (110).

In addition, one or more noise prevention protrusions (125) may be formed on facing surfaces of the flanges (122).

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a perspective view of an entire structure of a vehicle module clip according to the present invention;

FIG. 2 is a side view of the entire structure of the vehicle module clip according to the present invention;

FIG. 3 is a front view of the entire structure of the vehicle module clip according to the present invention;

FIG. 4 is a graph showing measured forces required for insertion and disassembly of a conventional module clip when the clip is perpendicularly inserted into and disassembled from a second member;

FIG. 5 is a graph showing measured forces required for insertion and disassembly of the module clip according to the present invention when the clip is perpendicularly inserted into and disassembled from a second member;

FIG. 6 is a graph showing measured forces required for insertion and disassembly of the conventional module clip when the clip is perpendicularly inserted into the second member and disassembled from the second member at an angle of 45°; and

FIG. 7 is a graph showing measured forces required for insertion and disassembly of the module clip according to the present invention when the clip is perpendicularly inserted into the second member and disassembled from the second member at an angle of 45°.

### DETAILED DESCRIPTION OF EXEMPLARY EMBODIMENTS

Hereinafter, exemplary embodiments of the present invention will be described in more detail with reference to the accompanying drawings. Moreover, terms and words used in the present specification and claims should not be interpreted as being limited to commonly used meanings or meanings in dictionaries and should be interpreted as having meanings and concepts which are consistent with the technological scope of the invention based on the principle that the inventors have appropriately defined concepts of terms in order to describe the invention in the best way.

Therefore, since the embodiments described in this specification and components illustrated in the drawings are only exemplary embodiments and do not represent the overall technological scope of the invention, it should be understood that there may be various equivalents or modifications substituting the exemplary embodiments at the time of filing of this application.

### Structure of Vehicle Module Clip

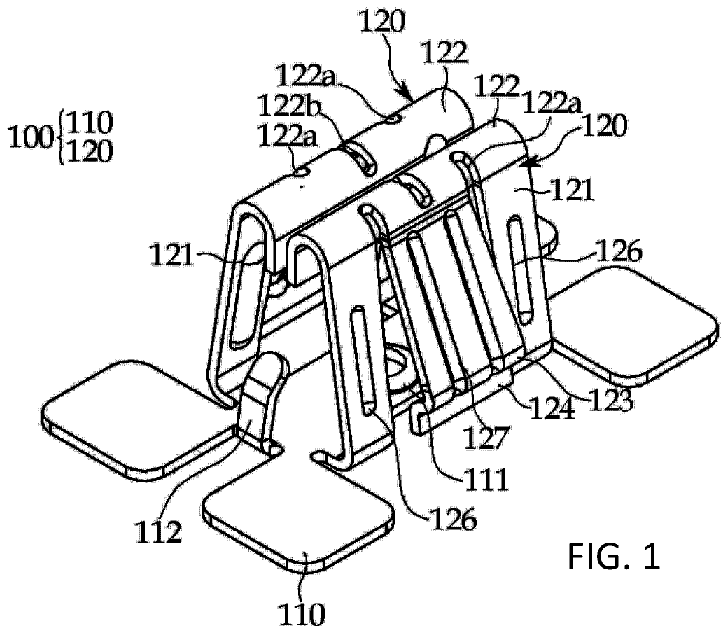

As illustrated in FIGS. 1 to 3, a module clip 100 according to the present invention includes a base 110 and a pair of hooks 120.

In particular, in the pair of hooks 120, portions of support arms 121 obliquely formed to face each other are formed to be widened outward from flanges 122 formed on end portions of support arms 121 to form two elastic arms 123. Accordingly, only one elastic arm 123 is formed on each of the hooks 120 so that the pair of hooks 120 are easily deformed not only to be easily assembled with a coupling hole 11 formed in a second member 10 using a small force but also to be conveniently disassembled therefrom at an angle of 45° using a small force when assembled to or disassembled from the coupling hole 11.

In this case, a width W and an angle θ between the pair of elastic arms 123 are in the range of 15.8 mm to 16.2 mm and 48° to 52°, respectively, and thus the pair of elastic arms 123 can be easily assembled and easily conveniently disassembled when disassembled and detached at a predetermined angle.

In addition, first soft grooves 122a are formed in both sides of the flanges 122 in contact with the elastic arm 123, at least one second soft groove 122b is formed between two first soft grooves 122a, and thus, the flange 122 can be flexibly deformed, and therefore, the module clip 100 according to the present invention not only can be assembled using a small force when assembled but can also be easily disassembled and detached when disassembled at a predetermined angle.

Hereinafter, such a structure will be described in more detail with reference to the accompanying drawings. In this case, a first member and the second member are members installed to face each other in a vehicle, and examples of the first member and the second member may be a head liner (first member) and an assist handle (second member).

### A. Base

As illustrated in FIGS. 1 to 3, the base 110 is integrally formed with the hooks 120, which will be described below, using a steel plate formed in a flat plate shape having a predetermined size. In this case, a fastening hole 111 is formed in a center of the base 110, the hooks 120 are integrally formed on both edges of the base 110, and guides 112 are formed between the hooks.

### 1. Fastening Hole

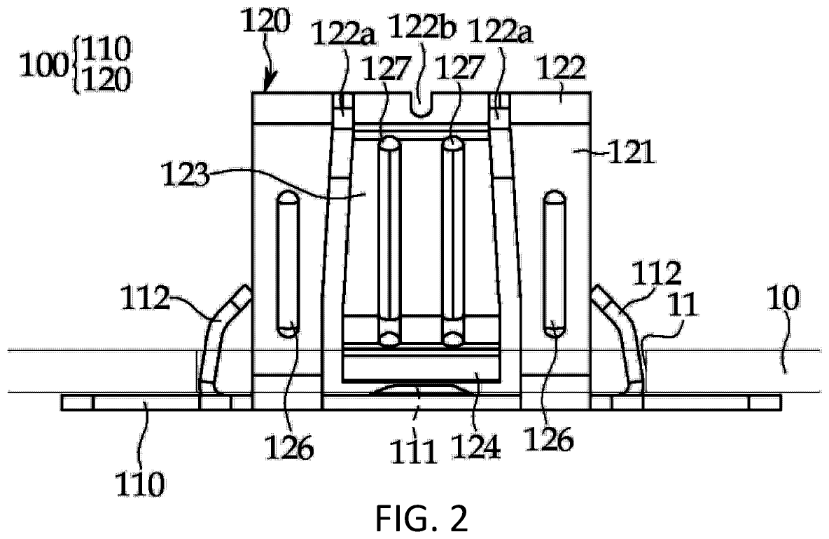

As illustrated in FIGS. 1 and 2, the fastening hole 111 is formed to pass through a middle portion of the base 110 and used when the base 110 is in close contact with and integrally fixed to the first member using a screw or the like.

### 2. Guide

As illustrated in FIGS. 1 to 3, two guides 112 are formed on the base 110 to be positioned between the hooks 120 that will be described below. In this case, the guides 112 are formed to face each other and formed in bent shapes such that a distance between the two guides 112 facing each other decreases in an outward direction of the base 110.

As described above, as the guides 112 are formed on end portions of both sides of the hooks 120 formed to face each other as illustrated in FIG. 2, when the module clip 100 according to the present invention is assembled, upper portions of the guides 112 are fitted into the coupling hole 11 of a second member 10 so that the module clip 100 is guided to be assembled at a predetermined position. In addition, lower portions of the guides 112 are in close contact with an inner surface of the coupling hole 11 formed in the second member 10 to prevent the movement of the module clip 100.

### B. Hook

As illustrated in FIGS. 1 to 3, the hooks 120 are integrally formed with the base 110 when a pressing process is performed on the base 110 and include the support arms 121 formed to be obliquely bent in a direction facing each other on both sides of the base 110, the flanges 122 formed to extend toward both sides from upper end portions of the support arms 121, the elastic arms 123 formed by cutting portions of the support arms 121 to be bent to spread outward from the flanges 122, steps 124 that are bent from end portions of the elastic arms 123 and caught in the coupling hole 11 of the second member 10, and first soft grooves 122a and second soft grooves 122b formed in the flanges 122. In addition, the hooks 120 may further include noise prevention protrusions 125 and beads 126 and 127.

### 1. Support Arm

As illustrated in FIGS. 1 to 3, the support arms 121 are to firmly connect the hooks 120 to the base 110 and are symmetrically formed on central portions of the hooks 120 for the connection.

In addition, in order to reinforce the strength of the support arms 121, at least one bead 126 may be further formed to extend in a longitudinal direction of the support arm 121. In this case, when several beads 126 are formed, the beads 126 may be formed in parallel.

Meanwhile, in the exemplary embodiment of the present invention, as illustrated in FIGS. 1 to 3, a portion of the support arm 121 is cut to form the elastic arm 123 that will be described below. Accordingly, the support arm 121 may be cut to have a predetermined size for forming the elastic arm 123, and therefore, the elastic arm 123 formed as described above is stably supported. The drawing shows an example of the support arm 121 formed in a rectangular shape.

### 2. Flange

As illustrated in FIGS. 1 to 3, the flanges 122 are formed by folding upper portions of the support arms 121 to have predetermined widths, and the pair of support arms 121 are formed to face and close to each other such that the flanges 122 are very close to each other. The flange 122 may be formed to have a width sufficient for supporting the elastic arm 123, which will be described below, when the elastic arm 123 is elastically deformed.

### 3. Elastic Arm and Step

As illustrated in FIGS. 1 to 3, the elastic arms 123 are formed by cutting portions, preferably central portions, of the support arms 121. In this case, the elastic arms 123 are formed by cutting the support arms 121 to be deformed with respect to the flanges 122 and widened outward from the flanges 122. Accordingly, a distance between the elastic arms 123 increases in an arrowhead shape and decreases when the elastic arms 123 are fitted into the coupling hole 11, the elastic arms 123 restore to an original state thereof when the elastic arms 123 are further fitted therein, and thus the elastic arms 123 provide an elastic force.

In the exemplary embodiment of the present invention, the angle θ and the width W formed between the two facing elastic arms 123 formed on the flanges 122 may be in the range of 48° to 52° and the range of 15.8 mm to 16.2 mm, respectively. This is because, as the angle θ formed between the two elastic arms 123 is smaller than that of the conventional case, the elastic arms 123 having the arrowhead shape that pass through the coupling hole 11 can be easily deformed to correspond to a diameter of the coupling hole 11 so as to reduce a force used for assembly. Conversely, when an external force is applied to the elastic arms 123 coupled to the coupling hole 11, since lengths of the elastic arms 123 are smaller than those of the conventional case, a greater force is applied when a smaller length is deformed as compared to a greater length, and thus a greater force is required to forcibly deform the elastic arms 123 to separate the elastic arms 123 from the coupling hole 11 so as to prevent the module clip from escaping or being easily separated.

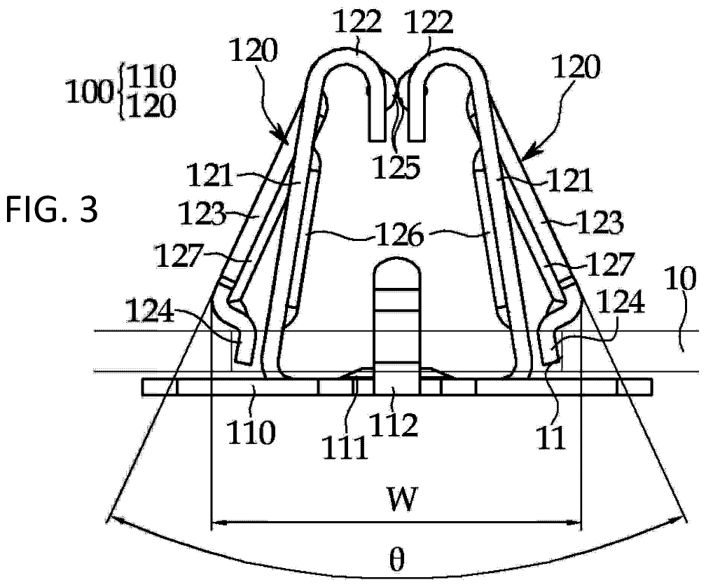

As illustrated in FIGS. 1 and 3, the steps 124 are formed on ends of the elastic arms 123, and in particular, as the hooks 120 are fitted into the coupling hole 11, the elastic arms 123 are elastically deformed in directions facing each other, when the elastic arms 123 are completely fitted, the elastic arms 123 restores to their original positions, and then the steps 124 are in close contact with an inner circumferential surface of the coupling hole 11 to perform a hooking operation.

The elastic arms 123 and the steps 124 formed as described above are for fixing the module clip 100 to the coupling hole 11 of the second member 10. When the hooks 120 are positioned at and pushed toward the coupling hole 11 of the second member 10, the elastic arms 123 are deformed in directions facing each other and fitted into the coupling hole 11 of the second member 10, and then elastically restored again, accordingly, the steps 124 are in close contact with the inner surface of the coupling hole 11, and thus the module clip 100 is firmly fixed to the coupling hole 11.

Meanwhile, at least one long bead 127 may be further formed in the elastic arm 123 in a longitudinal direction in order to improve the strength of the elastic arm 123. In this case, when several beads 127 are formed, the beads 126 may be formed in parallel.

### 4. First Soft Groove and Second Soft Groove

As illustrated in FIGS. 1 and 2, two first soft grooves 122a is each formed in one of two side portions of the flange 122 in contact with the elastic arm 123, and at least one second soft groove 122b is formed in the flange 122 to be positioned between the first soft grooves 122a.

In particular, the first soft grooves 122a and the second soft groove 122a weaken the rigidity of the flange 122 to allow the elastic arm 123, which is formed integrally with the flange 122 and elastically deforms, to be easily deformed. As a result, the hooks 120 are mounted using a small force when mounted and are easily disassembled using a small force at a predetermined angle when detached and disassembled.

### 5. Noise Prevention Protrusion

As illustrated in FIG. 3, one or more noise prevention protrusions 125, which suppress noise generated by the flanges 122 protruding in directions facing each other when the flanges 122 come into contact with each other, are provided on surfaces of the flanges 122 facing each other. In this case, since the noise prevention protrusions 125 comes into point contact with each other, noise generation can be minimized even when the module clip 100 is distorted by external force.

As described above, according to the present invention, as only one elastic arm is formed on each hook, and the soft groove is formed in the flange which supports the elastic arm, not only the assembly can be easily performed using a small force, but the detachment and disassembly can also be easily performed when disassembly is performed at an angle of 45°.

### Fitting Force and Disassembling (Separating) Force Analysis Result

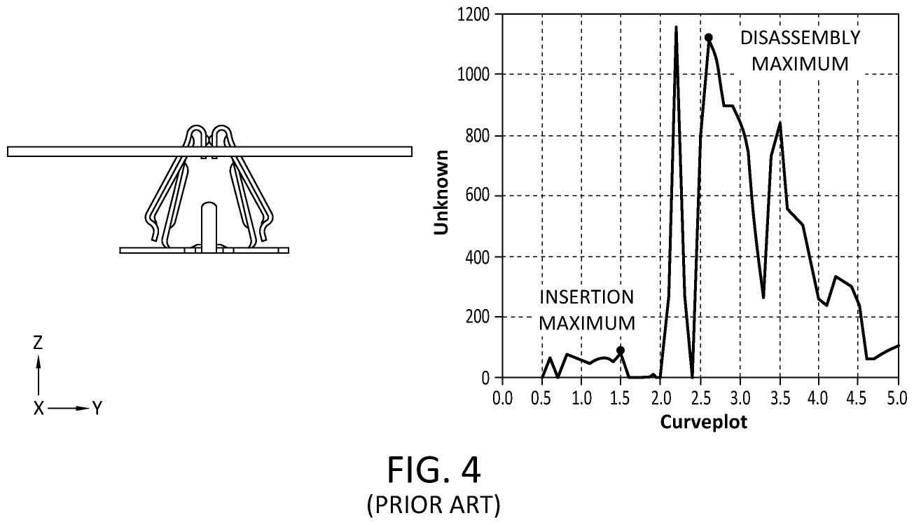

The results of simulation for forces used for insertion and disassembly of the module clip (example) according to the present invention formed as described above and the conventional module clip (comparative example) are shown in FIGS. 4 to 7.

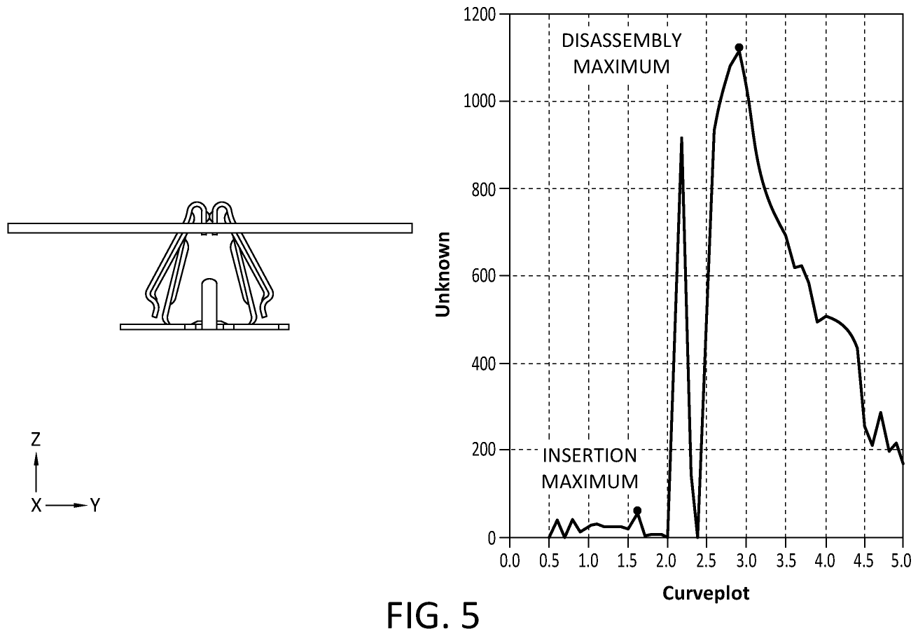

FIGS. 4 and 5 are graphs showing forces applied when the example and the comparative example are perpendicularly inserted into and assembled with the first member and then perpendicularly disassembled (separated) from the first member. As a result, it can be seen that, in the comparative example, a maximum force for insertion is 8.1 kgf and a force for disassembly (separation) is 113.7 kgf as shown in FIG. 4, and in the example, a maximum force for insertion is 5.5 kgf and a maximum force for disassembly is 113.8 kgf as shown in FIG. 5. As described above, the example of the module can be assembled using a small force.

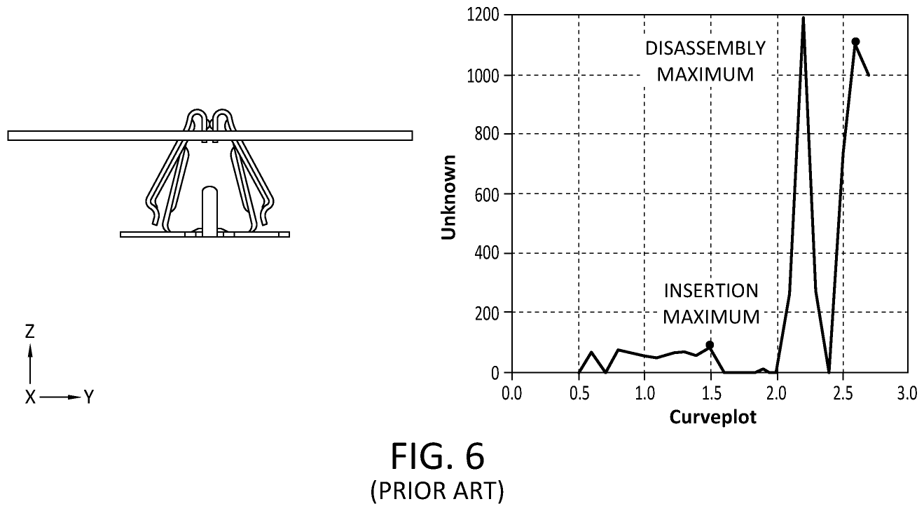

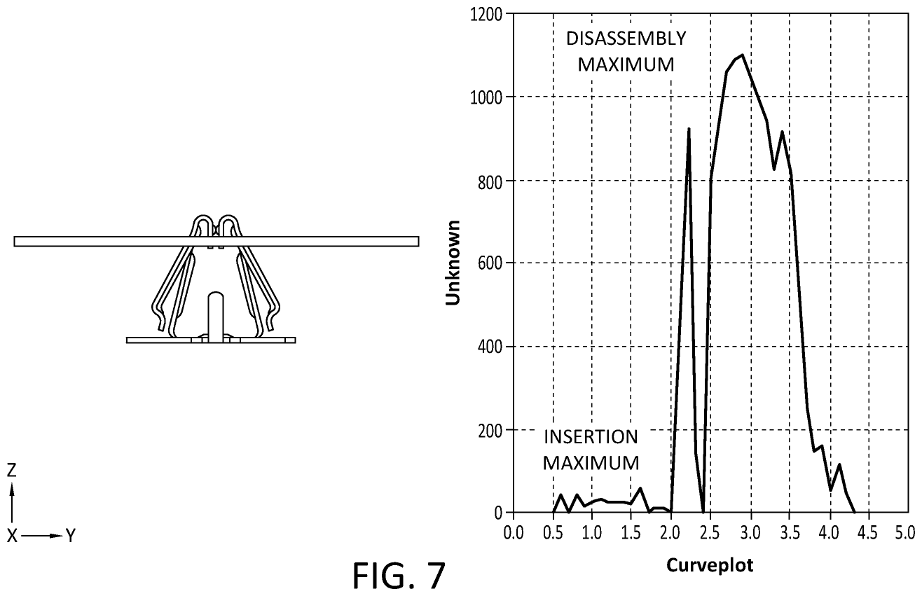

In addition, FIGS. 6 and 7 are graphs showing forces applied when the example and the comparative example are perpendicularly inserted into and assembled with the first member and then disassembled (separated) from the first member at an angle of 45°. As a result, it can be seen that, in the comparative example, a maximum force for insertion is 8.1 kgf and a force for disassembly (separation) is 117.9 kgf as illustrated in FIG. 6, and in the example, a maximum force for insertion is 5.5 kgf and a maximum force for removal is 111.8 kgf as illustrated in FIG. 7. As described above, the example of the module clip not only can be assembled using a small force, but also can be more easily disassembled when disassembled at an angle of 45° than when disassembled at a right angle.

A vehicle module clip according to the present invention has the following effects.
(1) As the number of elastic arms which constitute two facing hooks installed on a base is reduced to two from four, the hooks can be forcibly fitted into and assembled with a coupling hole of a second member using a small force when fitted into and assembled with the coupling hole.
(2) In addition, when the hooks assembled with the coupling hole is disassembled, the hooks can be easily conveniently disassembled by applying a small force.
(3) Accordingly, when the coupled module clip is disassembled, not only the module clip or other members can be prevented from being damaged, but the module clip can also be used again.
(4) Due to a thermal process, a machining deviation, or the like in the process of manufacturing the module clip, even when an insertion force applied for assembling the module clip and a disassembling force required for reversely disassembling (dismounting) the module clip become large, the module clip can be easily conveniently assembled and disassembled as the module clip is assembled and disassembled using two elastic arms.
(5) Meanwhile, as a soft groove is formed in a flange for supporting the elastic arms to allow the elastic arm to be easily deformed, the module clip can be assembled using a small force when assembled and easily disassembled at an angle of 45° using a small force when disassembled.

What is claimed is:

1. A vehicle module clip assembled by being fastened to a first member using a screw and fitted into a coupling hole (11) formed in a second member (10), the vehicle module clip comprising:
a base (110) fastened to the first member using the screw; and
a pair of hooks (120) that are bent from portions of both edges of the base (110) and fitted into and assembled with the coupling hole (11),
wherein the base (110) includes guides (112) positioned between the two hooks (120) and cut to protrude to face each other,
the guides (112) are formed such that a distance between two guides (112) facing each other decreases as a distance from the base (110) to the two guides (112) increases, and
the hooks (120) includes a pair of facing support arms (121) formed on both sides of the base (110) to be obliquely bent toward each other, flanges (122) that are bent from protruding ends of the support arms (121) to face each other and maintain a predetermined distance therebetween, two pairs of elastic arms (123) which are formed by cutting central portions of the support arms (112) to be unfolded outward from the flanges (122) and of which a width (W) and an angle (θ) between two elastic arms (123) are in the range of 15.8 mm to 16.2 mm and the range of 48° and 52°, respectively, steps (124) that are bent from end portions of the elastic arms 123 to face each other and caught in the coupling hole (11), two first soft grooves (122a) formed in portions of the flanges (122) in contact with the elastic arms (123), and one or more second soft grooves (122b) formed in the flanges 122 to be positioned between the two first soft grooves (122a).

2. The vehicle module clip of claim 1, wherein:
one or more beads (126) are further formed on the support arms (121) in an outward direction of the base (110); and
one or more beads (127) are further formed on the elastic arms (123) in the outward direction of the base (110).

3. The vehicle module clip of claim 1, wherein one or more noise prevention protrusions (125) are formed on facing surfaces of the flanges (122).
